(19) United States
(12) Patent Application Publication
(10) Pub. No.: US 2020/0097564 A1
(43) Pub. Date: Mar. 26, 2020

(54) SELECTING POINTS OF INTEREST FOR DISPLAY ON A PERSONALIZED DIGITAL MAP

(71) Applicant: GOOGLE LLC, Mountain View, CA (US)

(72) Inventor: Bailiang Zhou, Seattle, WA (US)

(21) Appl. No.: 16/141,647

(22) Filed: Sep. 25, 2018

(51) Int. Cl. G06F 17/30

(52) U.S. Cl. CPC G06F 17/3087; G06F 17/30241; G06F 17/30554; G06F 17/3053; G06F 17/30867

(57) ABSTRACT

A system determines a geographic area of interest to be presented to a user in a digital map. The system identifies a set of general POIs based on one or more signals unrelated to the user and, in a first instance, places respective indicators for the set of general POIs on the digital map of the geographic area of interest. In a second instance, the system identifies a set of personalized POIs of likely relevance to the user, based on signals specific to the user and independent of geography, and places respective indicators for the set of personalized POIs on the digital map of the geographic area along with some but not all of the indicators for the set of general POIs, so that density of the indicators does not exceed a certain threshold value.

### FIELD OF THE DISCLOSURE

The present disclosure relates to digital maps and, more particularly, to generating digital maps that include information of interest specifically to the user viewing the digital map.

### BACKGROUND

Today, numerous electronic devices such as personal computers, tablets, mobile phones, navigators provided as special-purpose devices or embedded into head units of vehicles, etc. can provide digital maps of geographic areas as well as step-by-step directions for navigating through geographic areas by driving, walking, bicycling, or using public transport. Special-purpose mapping applications or “apps” as well as general-purpose applications such as web browsers can provide digital maps and/or navigation directions.

Digital maps typically include information that is expected to be of interest to all users. For example, a digital map can include major landmarks, important roads, popular places, etc. However, users often are interested in different content when looking at a map of the same geographic area, both when looking at static maps or when viewing maps accompanying navigation routes.

Further, for a typical geographic area, the amount of information available today for display in the form of indicators (e.g., icons, symbols, labels) often is too high to avoid visual clutter or overlap between the indicators.

### SUMMARY

A system of this disclosure determines which point-of-interest (POI) indicators should be placed on a digital map in view of general, or non-personalized signals such as importance, popularity, rating, etc. of the corresponding place as well as personalized signals such as the profile of the user viewing the digital map. The system in some cases “promotes,” or raises the priority of POIs normally not visible at a particular zoom level, when these POIs are likely to match the user's interest. The system in this manner supports serendipitous discovery. Moreover, the system addresses the technical problem of efficiently managing limited screen real estate when placing POIs indicators on a digital map. Because the density of available information for a typical geographic region is too high to show all the available POIs, the system selects the POIs in a particular manner to avoid collisions between indicators or exceeding a certain density threshold for the unit of space.

One example embodiment of these techniques is a method for generating a personalized digital map for display on a user device. The method includes determining a geographic area of interest to be presented to a user in a digital ma and selecting a set of general points of interest (POIs) based on one or more signals unrelated to the user. In the first instance, the method includes placing respective indicators for the set of general POIs on the digital map of the geographic area of interest. In a second instance, the method includes selecting a second set of personalized POIs of likely relevance to the user, based on signals specific to the user and unrelated to geography, and placing respective indicators for the set of personalized POIs on the digital map of the geographic area and at least several of the indicators for the set of general POIs, including not placing at least one of the POIs from the set of general POIs in a portion of the digital map in which density of the indicators exceeds a certain threshold value.

Another example embodiment of these techniques is a system comprising one or more processing units and a computer-readable storing instructions. When executed by the one or more processing units, the instructions cause the computing system to determine a geographic area of interest to be presented to a user in a digital ma and selecting a set of general points of interest (POIs) based on one or more signals unrelated to the user; in the first instance, place respective indicators for the set of general POIs on the digital map of the geographic area of interest; and in a second instance, select a second set of personalized POIs of likely relevance to the user, based on signals specific to the user and unrelated to geography, and place respective indicators for the set of personalized POIs on the digital map of the geographic area and at least several of the indicators for the set of general POIs, including not place at least one of the POIs from the set of general POIs in a portion of the digital map in which density of the indicators exceeds a certain threshold value.

Another example embodiment of these techniques is a method for generating a personalized digital map for display on a user device. The method includes receiving, by one or more computing devices, an indication of a geographic area of interest to be presented to a user in a digital map. The method further includes executing a first query to determine a first set of personalized POIs of likely relevance to the user, based on a personal profile of the user, determining an amount of space available for POIs after the first set of POIs is placed on the digital map of the geographic area, executing a second query to determine a second set of POIs to be placed on the digital map of the geographic area, based on one or more signals unrelated to the user, and providing the first and second sets of POIs to a client device for displaying the digital map of the geographic area, by the one or more processors.

### BRIEF DESCRIPTION OF THE DRAWINGS

FIG. 1 is a block diagram of an example system in which techniques for providing indications of general and personalized points of interest (POIs) can be implemented;

FIG. 2 is a flow diagram of an example method for generating a personalized map for a user with indications of general and personalized POIs, which can be implemented in the system of FIG. 1;

FIG. 3 is a flow diagram of an example method for determining which POIs should be placed in a portion of a digital map in view of a space constraint, which also can be implemented in the system of FIG. 1;

FIG. 4 is a diagram that illustrates the technique of selecting indicators of POIs for placement on a digital map, which can be implemented in the system of FIG. 1;

FIG. 5 is a flow diagram of another example method for generating a personalized map for a user with indications of general and personalized POIs, which can be implemented in the system of FIG. 1; and

FIG. 6 illustrates an example digital map with visualization of a navigation route and personalized POIs, which the system of FIG. 1 can generate.

### DETAILED DESCRIPTION

Generally speaking, the system of this disclosure identifies personalized points of interest (POIs) that may be relevant specifically to the user in a certain geographic area and provides corresponding indicators on the digital map. The user can allow the system to generate various suggestions and recommendation based on the user's profile and activity by operating certain controls or installing certain applications, for example, and the system can identify POIs based on geographic and non-geographic signals in the user' profile. In some cases, the system uses direct references to geographic locations such as places the user explicitly labeled on the map or for which the user previously requested navigation directions, for example. In other cases, the system identifies geographic locations that may be of interest to the user based on general, non-geographic topics the user appears to like (e.g., music, cars, boats). Signals related to the general, non-geographic topics can come from non-geographic applications such as web browsers, calendars, etc.

When selecting personalized POIs, the system can promote (i.e., raise the priority or rank of) certain POIs that normally are not visible at the particular zoom level. For example, an indicator for a certain business normally may appear on the digital map at a zoom level N. The system may determine that because of a signal specific to a user, the indicator for this business should appear on the digital at a lower zoom level M, i.e., when the digital map encompasses a larger geographic area.

The system in some implementation assigns different weights to the signals in the user profile when determining whether, and to what extent, a POI should be promoted. For example, the system can assign a relatively large weight to a user's direct reference to a geolocated business (e.g., the user recently searched “Museum Art Museum,” and the digital map the system provides to the user includes the location of this museum), assign a smaller weight to non-geographic signals (e.g., the user previously searched for documents related to contemporary art, and the digital map the system provides to the user includes the location of a museum that includes contemporary art), and assign an even smaller weight to signals from the user's social graph (e.g., people in the user's social graph have recommended a business at a location included in the digital map).

In some cases, the system can provide a label to indicate why the POI was included in the digital map. For example, the digital map can include a label “searched last year” or “bookmarked in browser.” Alternatively or additionally, indicators for POIs corresponding to different sources can have different shapes, colors, and effects (e.g., blinking). Thus, indicators for general POIs can have different visualization than indicators for personalized POIs, and indicators for personalized POIs can differ as well to provide further guidance to the user.

In various scenarios, a user can select the geographic area for which the system identifies POIs by selecting the geographic area via the interface of a mapping application or by requesting navigation directions, for example.

Further, the system of this disclosure addresses the problem of generating a digital map populated with POI indicators without exceeding a certain threshold density. The system in some implementations first identifies personalized POIs for a geographic area by identifying general topics of interest (e.g., “fishing”) and running a set of geographic queries based on these general topics of interest for the geographic area, promotes the search results so that the corresponding indicators appear on the digital map of the geographic area, and then determines the remaining space available for indicators corresponding to general POIs identified based on signals unrelated to the user. Absent user-specific signals, the system selects these POIs for placement on the digital map based on priority ranking which can be based on such signals as popularity, prominence, importance, etc. Additionally or alternatively, the system can place indicators for personalized POIs and indicators for general POIs on the respective virtual layers of information, superimpose the virtual layers on the digital map, and resolve collisions between the indicators by comparing respective priorities of the personalized POIs and general POIs. In this manner, the system can efficiently manage the screen real estate.

An example computing system in which these techniques can be implemented is considered next.

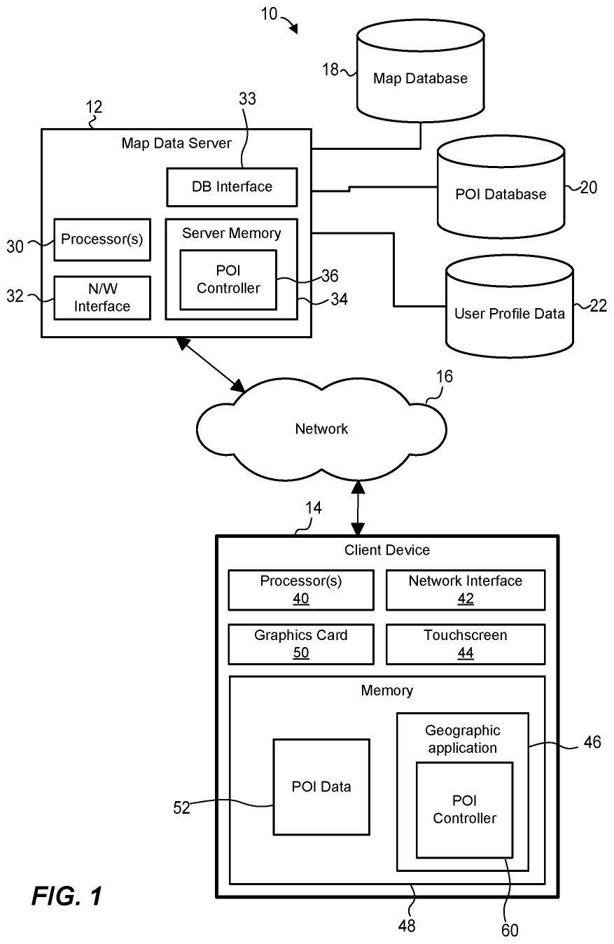

Referring to the block diagram of FIG. 1, an example computing system 10 in which a map data server 12 provides map data and POI data to a client device 14 via a communication network 16. The map data server 12 is coupled to a map database 18 storing map data, a POI database 20 storing indications of various places along with the corresponding ranking or priority, and a user profile database 22 storing profiles of various users.

The map data server 12 can be implemented as a single device or as a group of devices. One or more of these devices can include one or more processors 30, a network interface 32, a database interface 33, and a non-transitory computer-readable memory 34 that stores instructions executable on the one or more processors 30. These instructions can implement, among other software components, a server-side POI controller 36 that determines which POIs should be placed on a digital map, as discussed in detail below. More generally, the map data server 12 can include any suitable type of processing hardware configured to generate map image layers of the present disclosure.

The client device 14 can be a desktop computer, a laptop computer, a tablet computer, another type of a portable device such as a smartphone, a wearable device, etc. More generally, the techniques of this disclosure for placing POIs on digital maps can be utilized in any suitable computing device. The client device 14 can include a network interface 42 configured to communicate with the map data server 12 and other devices using any suitable protocols via the network 16, which can be a wide area network (WAN), a local area network (LAN), etc., and can include any suitable number of wired and/or wireless links. The client device 14 also can include a touchscreen 44 configured to receive typed and gesture-based input and to display images generated by various applications executing on the client device 14, including a geographic application 46. In other implementations, the client device 14 can include an output-only display and receive input via a keyboard, a mouse, a microphone, sensors configured to detect 2D and/or 3D gestures, etc. Further, the client device 14 can include one or more general-purpose processors 40, a non-transitory computer-readable memory 48, and a graphics card 50 (e.g., including one or more graphics processing units, or GPUs) with buffers and program memory that stores vertex and pixel shaders. The memory 48 can include persistent components (e.g., a hard disk) as well as non-persistent components (e.g., RAM). In other implementations, the client device 14 may include additional components or, conversely, not include some of the components illustrated in FIG. 1.

In the example implementation illustrated in FIG. 1, the geographic application 46 is stored in the memory 48 as a set of instructions executed by the one or more processors 40. The geographic application 46 can generate interactive digital maps and, depending on the implementation and/or scenario, obtain navigation directions, provide data related to geolocated businesses, retrieve and display geographic commercial data such as coupons and offers, etc. Depending on the implementation, the geographic application 46 can operate as a standalone application or as a component of another application such as a web browser, for example. The geographic application 46 includes a client-side POI controller 60 that operates on POI data 52.

A POI generation system of this disclosure can include the server-side POI controller 36 and/or the client-side POI controller 60. Depending on the implementation, the server-side POI controller 36 or the client-side POI controller 60 determines which POIs should be represented with indicators on a digital map which the geographic application 46 displays, which POIs should be omitted, how conflicts between indicators should be resolved, etc. The POI generation system generally can distribute this functionality between the controllers 36 and 60 in any suitable manner.

With continued reference to FIG. 1, the map database 18 can be implemented in a single storage device or multiple storage devices. The map database 18 can store map data that includes descriptions of geometry for various map features such as buildings and other structures, roads, parks, bodies of water, etc. Besides roads designed for vehicles, the map data can describe bicycle paths, pedestrian paths, railway paths, shipping routes, airlines routes, etc. Map features can be defined in a vector graphics format, according to which images are described in terms of geometrical primitives based on mathematical expressions, or another suitable scalable format. Depending on the implementation, map features can be defined in two dimensions (2D) only, in three dimensions (3D) as wireframes to which raster textures are applied, in “two-and-a-half” dimensions (2.5D) as 2D polygons “extruded” into the third dimension, etc. In some cases, map data also can include raster images in a bitmap format, for example. Further, map data also can include text label and various forms of metadata such as links to remote resources.

Further, the map data server 12 can organize and serve map data to client devices using map tiling. Map tiles generally correspond to 2D organization of geospatial data into a quadtree. Each tile at a given zoom level is divided into four tiles at the next level up to the highest level of magnification. Similarly, 3D organization of geospatial data can be implemented using octrees, in which a cubic volume contains map geometry at a certain zoom level and is subdivided into eight cubic volumes at the next zoom level, with each of the eight cubic volumes typically containing a more detailed map geometry. To map the surface of the Earth onto a plane for 2D representation, Mercator or another suitable projection can be used. Although the examples below refer to map data organized into 2D map tiles, the LOD and style parameter determination techniques of this disclosure can be extended to 3D map data organized into octrees.

The POI database 20 can store geographic coordinates of various places. The POI database 20 also can store for some of the places business data such as hours of operation, a description of products and services offered, user reviews, etc. The POIs need not always correspond to businesses and also can include landmarks (e.g., monuments, fountains), prominent buildings and other structures, locations of events, etc. In some implementations, the POI database 20 can store for each POI an indication of a type (e.g., hotel, restaurant, theater) so that the POI generation system can determine which icon to place on the digital map. Further, the POI database 20 can store for each POI an indication of priority or rank, e.g., a numeric score that corresponds to the estimated importance of the POI. Thus, a major landmark such as a Frank Lloyd Wright building can have a relatively high priority whereas a nearby restaurant can have a relatively low priority. When a user views a digital map of the corresponding area at a certain zoom level, the POI generation system can determine that it can include an indicator for one but not both of these POIs, and the POI generation system can use the priority values to determine which POI to represent on the digital map.

The user profile database 22 can include profile data for various users. A user of the client device 14 can indicate, by operating certain controls or installing certain applications, that the POI generation system can utilize signals included in the user's profile data to personalize digital maps. The POI generation system accordingly can use geographic signals and non-geographic signals. Examples of geographic signals can include previous geographic queries (e.g., “coffee near me”) as well as the user's selections of particular search results, navigation directions to certain locations, reviews submitted for brick-and-mortar businesses, etc. These geographic signals need not be limited to the geographic application 46 and come from other applications such as the web browser when the user bookmarks a web site related to a particular location, messaging applications via which the user can reference a particular location, mailing applications, etc. Examples of non-geographic signals include bookmarks not related to a specific geographic location but related to a topic for which POIs can exist. For example, the user can bookmark the site of a band that schedules a live performance at a particular location. As another example, the user can bookmark a web site dedicated to jazz, and the POI generation system in some cases can promote indicators of jazz clubs in view of this signal.

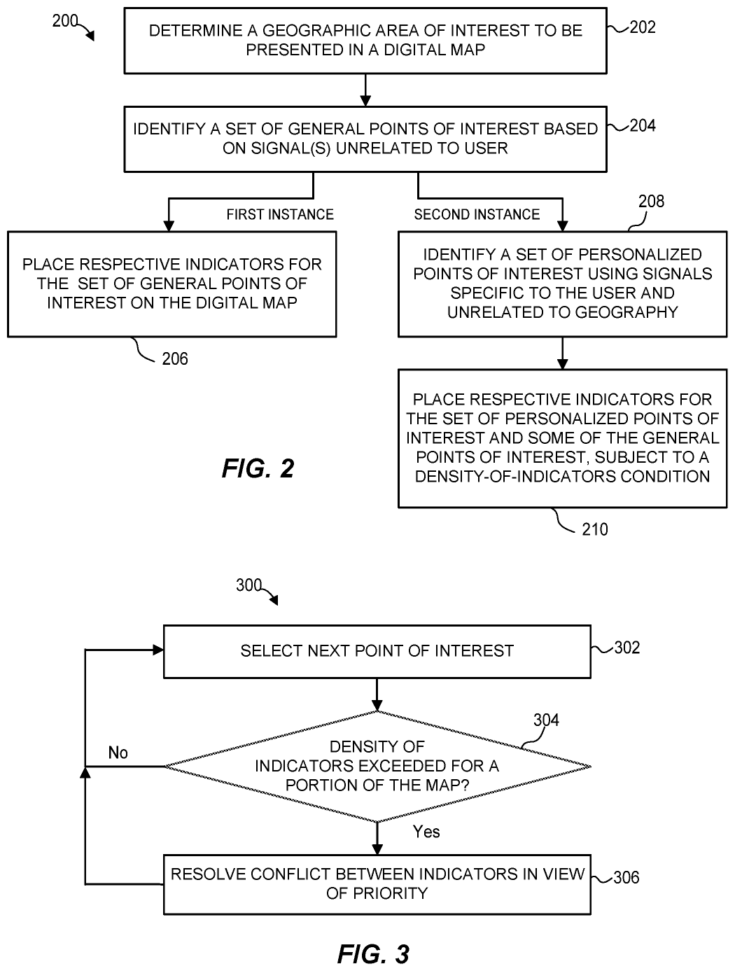

Now referring to FIG. 2, the POI generation system can implement a method 200 for generating a personalized map for a user with indications of general and personalized POIs, as a set of instructions executable by one or more processors, for example. For clarity, the discussion below refers to the POI generation system of FIG. 1, which includes the POI controller 36 and/or POI controller 60. However, the method 200 can be implemented in any suitable computing system, on the server and/or client side.

At block 202, the POI generation system can determine a geographic area of interest to be presented in a digital map. A user can select the geographic area by placing the map viewport over a certain area, by explicitly identifying the area via the mapping application 46 (e.g., “Seattle, Wash.”), or by requesting navigation directions from a certain starting location to a destination, where the geographic area of interest corresponds to the area around the current location of the user device 14.

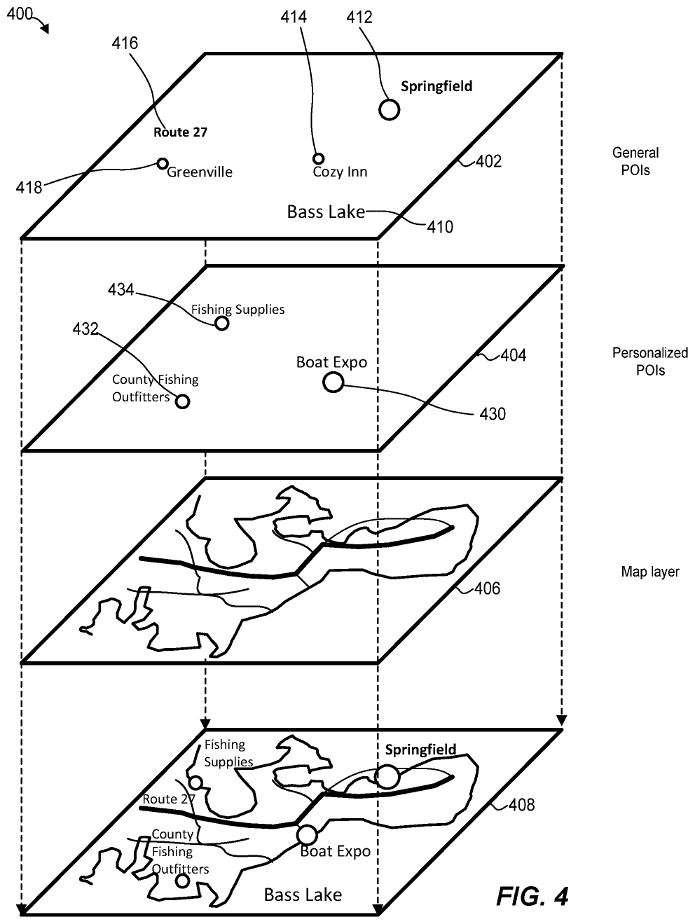

At block 204, the POI generation system can determine a set of general POIs based on signals unrelated to the user. Referring to FIG. 4, for example, a layer 402 of general POIs can include cities and towns (412 and 418, respectively), labels of routes (416) and bodies of water (410) and a POI with a certain popularity of importance, represented by an indicator 414. Some of the labels and indicators in the layer 402 represent entire geographic areas, e.g., a lake, and POIs in these cases can correspond to the geometric centers of such areas, for example, or the POI generation system in another implementation can process geographic labels for lakes, roads, parks, etc. separately from general POIs.

At block 206, the POI generation system can operate in a first instance to display only general POIs on the digital map, without displaying personalized POIs. Referring again to FIG. 4, for example, the POI generation system can apply the layer 402 of general POIs to a map layer 406 to generate a version of a digital map in which indicators for each of the general POIs in the layer 402 are visible on the digital map.

In another instance, however, the POI generation system can identify a set of personalized POIs using signals specific to the user (block 208). The POI generation system can utilize signals unrelated to geography in some cases, as discussed above. An example of a set of personalized POIs in the format of a virtual layer is depicted in FIG. 4 as layer 404. The POI 430 in this example can correspond to a prior search for the specific event and place, and accordingly the POI generation system can assign a relatively large weight to this POI. The POIs 432 and 434 on the other hand can correspond to places that generally appear to correspond to the user's interest in fishing, and thus the POI generation system can assign smaller weights to these POIs. The POI generation system then can promote the POIs 430, 432, and 434 according to the assigned weight, with larger weights resulting in larger increases in priority. In some implementations, the POI generation system also can visually indicate the difference in weights by using different sizes, colors, or effect of the indicators.

At block 210, the POI generation system places respective indicators for the personalized POIs and some of the general POIs on the digital map. In particular, the POI generation system determines whether the density of indicators for a certain unit of space (e.g., an S2 cell, a map tile at a zoom level) exceeds a predefined threshold. Referring again to FIG. 4, the POI generation system can place the layers 402 and 404 onto the layer 406 to generate a digital map 408 with general and personalized POIs.

In this example, placing indicators for both the general POI 414 and the personalized POI 430 on the digital map results in excessive density of POIs in the corresponding portion of the map. The POI generation system in one example implementation resolves the conflict between the POIs 414 and 430 by comparing the priority of the general POI 414 to the priority of the POI 430, which was increased by way of a promotion as discussed above.

In another example implementation, the POI generation system always resolves conflicts between general POIs and personalized POIs in favor of the personalized POIs. The POI generation system in this case places indicators for all the POIs in the layer 404 on the digital map first, determines the amount of remaining space, and places those of the general POIs in the layer 402 on the digital map that do not result in excessive indicator density.

For further clarity, FIG. 3 illustrates a method 300 for determining which POIs should be placed in a portion of a digital map in view of a space constraint, which the POI generation system can execute at block 210 of the method 200, for example.

The method 300 begins at block 302, where the POI generation system selects the next POI from a list of general POIs and a list of personalized POIs. The POI generation system can check whether placing an indicator for the next selected POI would result in the density of indicators exceeding a certain threshold value. When the density threshold is not exceeded, the POI generation system places the indicator on the digital map, and the flow proceeds to block 302. Otherwise, if the density threshold is exceeded, the flow proceeds to block 306. The POI generation system resolves the conflict between the indicators that result in excessive density at block 306, and the flow returns to block 302.

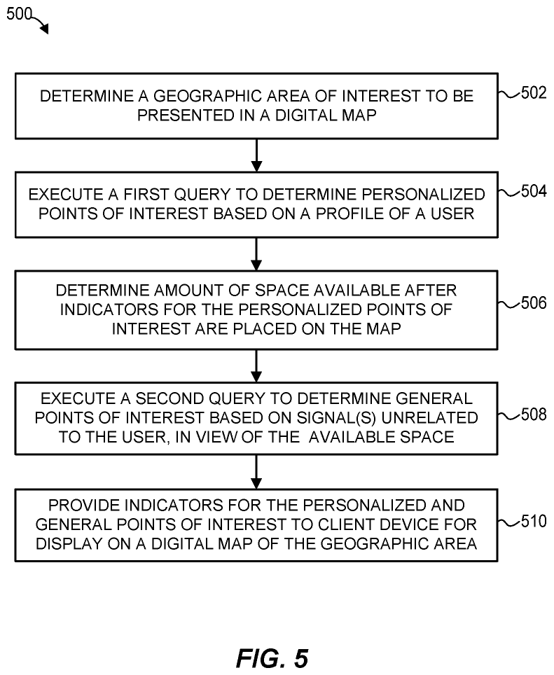

FIG. 5 is a flow diagram of another example method 500 for generating a personalized map for a user with indications of general and personalized POIs, which can be implemented in the system of FIG. 1. Similar to the method 200, the method 500 can be implemented in any suitable computing system, on the server and/or client side, but the discussion below for clarity refers to the POI generation system of FIG. 1.

At block 502, the POI generation system can determine a geographic area of interest to be presented in a digital map, similar to block 202 discussed above. Next, at block 504, the POI generation system executes a first query to determine personalized POIs based on the profile of the user. The first query can include multiple component queries such as “find places in the specified geographic area matching interest I₁,” “find places in the specified geographic matching interest I₂,” “find places in the specified geographic area for which the user requested navigation directions in the last 12 months,” “find places in the specified geographic area referenced in the user's browser bookmarks,” etc. The first query can produce a set of personalized POIs such as those illustrated in the layer 402 in FIG. 4.

Next, at block 506, the POI generation system can determine an amount of space available after indicators for the personalized POIs are placed on the digital map. In particular, the POI generation system can determine the amount of space for each map tile, for the entire map visible in the map viewport, or for any suitable unit of space.

The POI generation system then can execute a second query to produce a set of generalized POIs (block 508). However, the POI generation system can execute the second query subject to the space constraint determined at block 506. To this end, the POI generation system can for example execute a query for only important general POIs. As a more specific example, for a certain geographic area depicted at zoom level Z, the POI generation system normally can execute a query to determine a set of general POIs by querying the POI database 20 (see FIG. 1) for any POIs whose ranking or priority exceeds N; however, at block 508, the POI generation system can execute a query to determine a set of general POIs whose ranking or priority exceeds M, where M>N. In this manner, the POI generation system can obtain a smaller set of POIs in response to the second query and thereby reduce the amount of memory required to execute the queries as well as the number of operations required to resolve conflicts.

According to another approach, the POI generation system executes at least some of the queries in advance as a batch job to avoid executing real-time queries and thereby slowing down the process of generating digital maps with POI indicators. For example, for a certain geographic area which the user visits often, the POI generation system can execute a query for personalized POIs to prepare the layer 402 (see FIG. 4) in advance.

At block 510, the POI generation system can place indicators for the personalized an general POIs on the digital map.

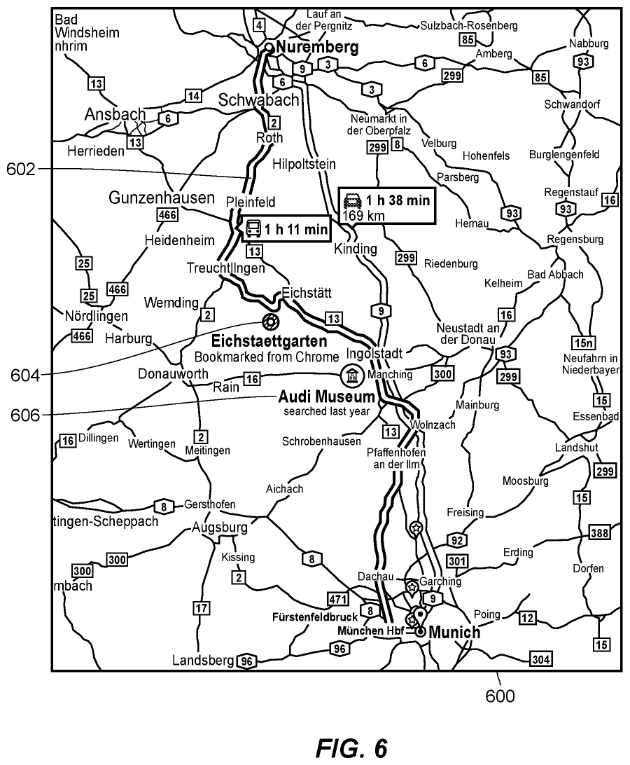

As another example, FIG. 6 depicts example digital map with visualization of a navigation route and personalized POIs, which the POI general system can generate. The digital map 600 includes a visualization of the navigation route 602. The POI generation system in this example identifies the POI Eichstaettgarten as a place the user bookmarked via a web browser. The POI generation system accordingly places an indicator 604 in the form of a general place icon on the digital map along with a label indicating the source of the POI.

The POI generation further identifies the POI Audi Museum based on the user's prior searches. The POI generation system accordingly places an indicator 606 in the form of a museum icon on the digital map along with a label indicating the source of the POI. In addition to indicating that the personalized POI was identified based on a prior search, the POI generation system in this case also indicates how recently the search occurred.

### Additional Considerations

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter of the present disclosure.

Additionally, certain embodiments are described herein as including logic or a number of components and modules. Modules may constitute either software modules (e.g., code stored on a machine-readable medium) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module in dedicated and permanently configured circuitry, or in temporarily configured circuitry (e.g., configured by software) may be driven by cost and time considerations.

Accordingly, the term hardware should be understood to encompass a tangible entity, be that an entity that is physically constructed, permanently configured (e.g., hardwired), or temporarily configured (e.g., programmed) to operate in a certain manner or to perform certain operations described herein. As used herein “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configured on a processor, for example, to constitute a particular hardware module at one instance of time and to constitute a different hardware module at a different instance of time.

Hardware modules can provide information to, and receive information from, other hardware. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The methods 200, 300, and 500 may include one or more function blocks, modules, individual functions or routines in the form of tangible computer-executable instructions that are stored in a non-transitory computer-readable storage medium and executed using a processor of a computing device (e.g., a server, a personal computer, a smart phone, a tablet computer, a smart watch, a mobile computing device, or other personal computing device, as described herein). The methods 200, 300, and 500 may be included as part of any backend server (e.g., a map data server, a navigation server, or any other type of server computing device, as described herein), portable device modules of the example environment, for example, or as part of a module that is external to such an environment. Though the figures may be described with reference to the other figures for ease of explanation, the methods 200, 300, and 500 can be utilized with other objects and user interfaces. Furthermore, although the explanation above describes steps of the methods 200, 300, and 500 being performed by specific devices, this is done for illustration purposes only.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as an SaaS. For example, as indicated above, at least some of the operations may be performed by a group of computers (as examples of machines including processors), these operations being accessible via a network (e.g., the Internet) and via one or more appropriate interfaces (e.g., APIs).

Still further, the figures depict some embodiments of the example environment for purposes of illustration only. One skilled in the art will readily recognize from the following discussion that alternative embodiments of the structures and methods illustrated herein may be employed without departing from the principles described herein.

Upon reading this disclosure, those of skill in the art will appreciate still additional alternative structural and functional designs for placing POIs on digital maps through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method for generating a personalized map for a user, the method comprising:
determining, by one or more computing devices, a geographic area of interest to be presented to a user in a digital map;
identifying, by the one or more computing devices, a set of general POIs based on one or more signals unrelated to the user;
in a first instance, placing respective indicators for the set of general POIs on the digital map of the geographic area of interest;
in a second instance:
identifying, by the one or more computing devices, a set of personalized POIs of likely relevance to the user, based on signals specific to the user and independent of geography, and
placing respective indicators for the set of personalized POIs on the digital map of the geographic area and at least several of the indicators for the set of general POIs, including not placing an indicator for at least one of the POIs in the set of general POIs in a portion of the digital map in which density of the indicators exceeds a certain threshold value.

2. The method of claim 1, wherein placing the indicators on the digital map in the second instance includes:
determining, by the one or more processors, an amount of space available for the indicators for the first set of POIs after the indicators for the second set of POIs are placed on the digital map of the geographic area; and
determining which of the indicators for the first set of POIs should be selected for placement on the digital based on the determined amount of available space.

3. The method of claim 2, wherein selecting POIs in the set of general POIs for placement on the digital map includes ranking the POIs in the set of general POIs based on importance.

4. The method of claim 1, wherein placing the indicators for the set of personalized POIs on the digital map includes displaying an indication of a source of the POI.

5. The method of claim 1, wherein identifying the set of personalized POIs includes:
obtaining, based on a profile of the user, an indication of a potential topic of interest; and
executing, by the one or more processors, a query for the geographic area of interest to identify the set of personalized POIs.

6. The method of claim 5, wherein obtaining the indication of a potential topic of interest includes obtaining a list of websites bookmarked by the user.

7. The method of claim 1, further comprising:
generating a navigation route to guide the user from a starting location to a destination, wherein determining the geographic area of interest includes selecting a geographic area along the generated navigation route.

8. The method of claim 7, further comprising:
in response to determining that a computing device operated by the user has advanced along the navigation route, (i) determining a new geographic area of interest and (ii) identifying a revised set of personalized POIs and a revised set of general POIs for the new geographic area of interest.

9. The method of claim 1, wherein identifying the set of personalized POIs includes:
executing a first query to determine the set of personalized POIs, and
subsequently to executing the first query, executing, by the one or more processors, executing a second query to determine the set of general POIs to be placed on the digital map of the geographic area, for the amount of available space.

10. The method of claim 1, wherein the digital map of the geographic area of interest has a first zoom level; and wherein identifying the set of personalized POIs includes:
identifying, by the one or more computing devices, a plurality of general POIs corresponding to a second zoom level but not the first zoom level, wherein the second zoom level corresponds to a higher level of magnification than the first zoom level; and
generating the set of personalized POIs by promoting some of the plurality of general POIs, based on the signals specific to the user.

11. A computing system comprising:
one or more processing units; and
a computer-readable storing thereon instructions that, when executed by the one or more processing units, cause the computing system to:
determine a geographic area of interest to be presented to a user in a digital map,
identify a set of general POIs based on one or more signals unrelated to the user;
in a first instance, place respective indicators for the set of general POIs on the digital map of the geographic area of interest;
in a second instance:
identify a set of personalized POIs of likely relevance to the user, based on signals specific to the user and independent of geography, and
place respective indicators for the set of personalized POIs on the digital map of the geographic area and at least several of the indicators for the set of general POIs, including not place an indicator for at least one of the POIs in the set of general POIs in a portion of the digital map in which density of the indicators exceeds a certain threshold value.

12. The computing system of claim 11, wherein place the indicators on the digital map in the second instance, the instructions cause the computing system to:
determine an amount of space available for the indicators for the first set of POIs after the indicators for the second set of POIs are placed on the digital map of the geographic area; and
determine which of the indicators for the first set of POIs should be selected for placement on the digital based on the determined amount of available space.

13. The computing system of claim 12, wherein to select POIs in the set of general POIs for placement on the digital map, the instructions cause the computing system to rank the POIs in the set of general POIs based on importance.

14. The computing system of claim 11, wherein to place the indicators for the set of personalized POIs on the digital map, the instructions cause the computing system to display an indication of a source of the POI.

15. The computing system of claim 11, wherein to identify the set of personalized POIs, the instructions cause the computing system to:
obtain, based on a profile of the user, an indication of a potential topic of interest; and
execute a query for the geographic area of interest to identify the set of personalized POIs.

16. The computing system of claim 15, wherein to obtain the indication of a potential topic of interest, the instructions cause the computing system to obtain a list of websites bookmarked by the user.

17. The computing system of claim 11, wherein the instructions further cause the computing system to:
generate a navigation route to guide the user from a starting location to a destination, and wherein to determine the geographic area of interest, the instructions cause the computing system to select a geographic area along the generated navigation route.

18. The computing system of claim 17, wherein the instructions further cause the computing system to:
in response to determining that a computing device operated by the user has advanced along the navigation route, (i) determine a new geographic area of interest and (ii) identify a revised set of personalized POIs and a revised set of general POIs for the new geographic area of interest.

19. The computing system of claim 11, wherein to identify the set of personalized POIs, the instructions cause the computing system to:
execute a first query to determine the set of personalized POIs, and
subsequently to executing the first query, execute a second query to determine the set of general POIs to be placed on the digital map of the geographic area, for the amount of available space.

20. The computing system of claim 11, wherein the digital map of the geographic area of interest has a first zoom level; and wherein to identify the set of personalized POIs, the instructions cause the computing system to:
Identify a plurality of general POIs corresponding to a second zoom level but not the first zoom level, wherein the second zoom level corresponds to a higher level of magnification than the first zoom level; and
generate the set of personalized POIs by promoting some of the plurality of general POIs, based on the signals specific to the user.
